(19) United States
(12) Patent Application Publication
(10) Pub. No.: US 2022/0377579 A1
(43) Pub. Date: Nov. 24, 2022

(54) CONTROLLING OF NETWORK FUNCTION

(71) Applicant: NOKIA SOLUTIONS AND NETWORKS OY, Espoo (FI)

(72) Inventors: Zhi WANG, Qingdao, Shandong (CN); Qingbo ZHANG, Qingdao, Shandong (CN)

(21) Appl. No.: 17/761,524

(22) PCT Filed: Sep. 19, 2019
(86) PCT No.: PCT/CN2019/106756

§ 371 Date: Mar. 17, 2022

(51) Int. Cl. H04W 24/02; H04W 8/22

(52) U.S. Cl. CPC H04W 24/02; H04W 8/22

(57) ABSTRACT

Embodiments of the disclosure provide a method, device and computer readable medium for controlling network functions. According to embodiments of the present disclosure, network functions can be updated dynamically by establishing a new interface between NRF device and a management device. Thus, more flexible network functions are achieved. Further, according to embodiments of the present disclosure, a solution is proposed to enable dynamic controlling in 5G Service-Based Architecture to provide appropriate continuous service automatically.

### FIELD

Embodiments of the present disclosure generally relate to communication techniques, and more particularly, to methods, devices and computer readable medium for controlling of network function.

### BACKGROUND

In recent communication networks, several new technologies have been proposed. For example, a fifth generation (5G) system architecture which is service based architecture has been proposed. The system functionality in the system architecture is achieved by a set of network functions (NF) providing services to other authorized NFs to access their services. A NF service is one type of capability exposed by a NF service producer to other authorized NF service consumers through a service based interface. A NF service may support one or more NF service operation(s).

### SUMMARY

Generally, embodiments of the present disclosure relate to a method for service chain and the corresponding communication devices.

In a first aspect, embodiments of the disclosure provide a first device. The first device comprises at least one processor; and a memory coupled to the at least one processor, the memory storing instructions therein, the instructions, when executed by the at least one processor, causing the first device to: retrieve, at a first device, profiles concerning one or more network functions which have registered with the first device. The first device is also caused to determine whether an update for the one or more network functions is triggered based on the profiles, the profiles indicating services supported by the one or more network functions and usage conditions of the one or more network functions. The first device is further caused to in accordance with a determination that the update is triggered, transmit, to a second device, an indication to update the one or more network functions. The first device is yet caused to receive a further indication concerning the completion of the update.

In a second aspect, embodiments of the disclosure provide a second device. The second device is caused to receive, from a first device and at a second device, an indication to update one or more network functions which have registered with the first device. The second is also caused to update the one or more network functions based on the indication. The second is also caused to transmit a further indication concerning the completion of the update.

In a third aspect, embodiments of the disclosure provide a third device. The third device is caused to transmit a request for a service to a first device with which one or more network functions have registered, an update of the one or more network functions being triggered based on the request. The third device is also caused to receive, a response to the request from the first device, the response indicating the service to be implemented by a network function registered with the first device.

In a fourth aspect, embodiments of the disclosure provide a method. The method comprises retrieving, at a first device, profiles concerning one or more network functions which have registered with the first device. The method also comprises determining whether an update for the one or more network functions is triggered based on the profiles, the profiles indicating services supported by the one or more network functions and usage conditions of the one or more network functions. The method further comprises in accordance with a determination that the update is triggered, transmitting, to a second device, an indication to update the one or more network functions. The method yet comprises receiving a further indication concerning the completion of the update.

In a fifth aspect, embodiments of the disclosure provide a method. The method comprises receiving, from a first device and at a second device, an indication to update one or more network functions which have registered with the first device. The method further comprises updating the one or more network functions based on the indication. The method yet comprises transmitting a further indication concerning the completion of the update.

In a sixth aspect, embodiments of the disclosure provide a method. The method comprises transmitting, at a third device, a request for a service to a first device with which one or more network functions have registered, an update of the one or more network functions being triggered based on the request. The method further comprises receiving, a response to the request from the first device, the response indicating the service to be implemented by a network function registered with the first device.

In a seventh aspect, embodiments of the disclosure provide an apparatus. The apparatus comprises means for retrieving, at a first device, profiles concerning one or more network functions which have registered with the first device; means for determining whether an update for the one or more network functions is triggered based on the profiles, the profiles indicating services supported by the one or more network functions and usage conditions of the one or more network functions; and means for in accordance with a determination that the update is triggered, transmitting, to a second device, an indication to update the one or more network functions. The apparatus yet comprises means for receiving a further indication concerning the completion of the update.

In an eighth aspect, embodiments of the disclosure provide an apparatus. The apparatus comprises means for receiving, from a first device and at a second device, an indication to update one or more network functions which have registered with the first device. The apparatus also comprises means for updating the one or more network functions based on the indication. The apparatus yet comprises means for transmitting a further indication concerning the completion of the update.

In a ninth aspect, embodiments of the disclosure provide an apparatus. The apparatus comprises means for transmitting, at a third device, a request for a service to a first device with which one or more network functions have registered, an update of the one or more network functions being triggered based on the request; and means for receiving, a response to the request from the first device, the response indicating the service to be implemented by a network function registered with the first device.

In a tenth aspect, embodiments of the disclosure provide a computer readable medium. The computer readable medium stores instructions thereon, the instructions, when executed by at least one processing unit of a machine, causing the machine to implement the method according to the fourth aspect, the fifth aspect or the sixth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates a schematic diagram of a communication system according to embodiments of the present disclosure;

FIGS. 2A and 2B illustrate schematic diagrams of devices according to embodiments of the present disclosure;

FIG. 3 illustrates a flow chart of a method implemented at a communication device according to embodiments of the present disclosure;

FIG. 4 illustrates a flow chart of a method implemented at a communication device according to embodiments of the present disclosure;

FIG. 5 illustrates a flow chart of a method implemented at a communication device according to embodiments of the present disclosure;

FIG. 6 illustrates a flow chart of a method implemented at a communication device according to embodiments of the present disclosure;

FIG. 7 illustrates a schematic diagram of interactions among devices according to embodiments of the present disclosure;

FIG. 8 illustrates a schematic diagram of interactions among devices according to embodiments of the present disclosure;

FIG. 9 illustrates a flow chart of a method implemented at a communication device according to embodiments of the present disclosure;

FIG. 10 illustrates a schematic diagram of a device according to embodiments of the present disclosure; and

FIG. 11 shows a block diagram of an example computer readable medium in accordance with some embodiments of the present disclosure.

Throughout the figures, same or similar reference numbers indicate same or similar elements.

### DETAILED DESCRIPTION OF EMBODIMENTS

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two functions or acts shown in succession may in fact be executed concurrently or may sometimes be executed in the reverse order, depending upon the functionality/acts involved.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future.

Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system. For the purpose of illustrations, embodiments of the present disclosure will be described with reference to 5G communication system.

The term “network device” used herein includes, but not limited to, a base station (BS), a gateway, a registration management entity, and other suitable device in a communication system. The term “base station” or “BS” represents a node B (NodeB or NB), an evolved Node (eNodeB or eNB), a NR NB (also referred to as a gNB), a Remote Radio Unit (RRU), a radio header (RH), a remote radio head (RRH), a relay, a low power node such as a femto, a pico, and so forth.

The term “terminal device” used herein includes, but not limited to, “user equipment (UE)” and other suitable end device capable of communicating with the network device. By way of example, the “terminal device” may refer to a terminal, a Mobile Terminal (MT), a Subscriber Station (SS), a Portable Subscriber Station, a Mobile Station (MS), or an Access Terminal (AT).

The term “circuitry” used herein may refer to one or more or all of the following:

(a) hardware-only circuit implementations (such as implementations in only analog and/or digital circuitry) and

(b) combinations of hardware circuits and software, such as (as applicable):

(i) a combination of analog and/or digital hardware circuit(s) with

software/firmware and

(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As mentioned above, the service based architecture has been proposed. Network Functions may offer different functionalities and thus different NF services. Each of the NF services offered by a Network Function shall be self-contained, acted upon and managed independently from other NF services offered by the same Network Function (e.g. for scaling, healing). A Control Plane Network function (NF) within the fifth generation (5G) Core network (CN) may expose its capabilities as services via its service based interface, which can be re-used by Control Plane CN NFs. The NF service discovery enables a CN NFs to discover NF instance(s) that provide the expected NF service(s). The Network Repository Function (NRF) supports the following functionality:
Receives NF Discovery Request from NF instance, and provides the information of the discovered NF instances (be discovered) to the NF instance;
Maintains the NF profile of available NF instances and their supported services.

Table 1 shows some NRF service operations.

TABLE 1

| | | Operation | |
|---|---|---|---|
| Service Name | Service Operations | Semantics | Example Consumer(s) |
| Nnrf_NFManagement | NFRegister | Request/Response | AMF, SMF, UDM, AUSF, NEF, PCF, |
| | | | SMSF, NSSF, UPF, BSF, CHF |
| | NFUpdate | Request/Response | AMF, SMF, UDM, AUSF, NEF, PCF, |
| | | | SMSF, NSSF, UPF, BSF, CHF |
| | NFDeregister | Request/Response | AMF, SMF, UDM, AUSF, NEF, PCF, |
| | | | SMSF, NSSF, UPF, BSF, CHF |
| | NFStatusSubscribe | Subscribe/Notify | AMF, SMF, PCF, NEF, NSSF, SMSF, |
| | | | AUSF, CHF, NRF |
| | NFStatusNotify | | AMF, SMF, PCF, NEF, NSSF, SMSF, |
| | | | AUSF, CHF |
| | NFStatusUnSubscribe | | AMF, SMF, PCF, NEF, NSSF, SMSF, |
| | | | AUSF, CHF, NRF |
| Nnrf_NFDiscovery | Request | Request/Response | AMF, SMF, PCF, NEF, NSSF, SMSF, |
| | | | AUSF, CHF, NRF |
| Nnrf_AccessToken | Get | Request/Response | AMF, SMF, PCF, NEF, NSSF, SMSF, |
| | | | AUSF, UDM |

For the NRF to properly maintain the information of available NF instances and their supported services, each NF instance informs the NRF of the list of NF services that it supports. For the NRF to properly maintain the information of available NF instances and their supported services, each NF instance informs the NRF of the list of NF services that it supports.

In the new 5G Services Based Architecture (SBA), once a NF registers its services with the NRF, it then simply exposes services that any authorized consumer can consume, rather than having to define a new point-to-point interface and the procedures between the two network functions as requiring. This offers greater flexibility and more efficiency by decoupling the service consumer from the service producer.

However, current 5G SBA only defines the capability of NF discovery and authorized NF service access. It lacks of the capability of virtual network function (VNF) controlling while this is a key capability for providing dynamic appropriate continuous service for NF consumer. For example, the scenarios like no available NF is found in NRF or all NF registered on NRF doesn't match the Nnrf_NFDiscovery Request or internal selection policies of the NRF for some reason like high working load, etc. . . . will result in service failure or service discontinuity of current 5G SBA, which would be a big problem for CSPs. Therefore, how to fill above gap on 5G SBA with enabling VNF controlling is an unavoidable technical problem in very near future.

According to embodiments of the present disclosure, network functions can be updated dynamically by establishing a new interface between NRF device and a management device. Thus, more flexible network functions are achieved. Further, according to embodiments of the present disclosure, a solution is proposed to enable dynamic controlling in 5G Service-Based Architecture to provide appropriate continuous service automatically.

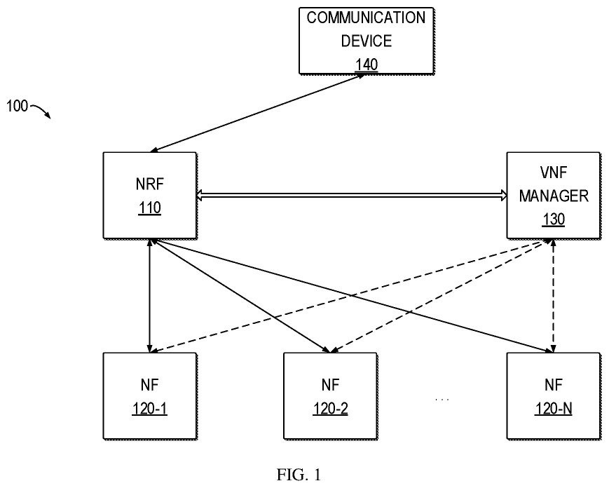

FIG. 1 illustrates a schematic diagram of a communication system 100 in which embodiments of the present disclosure can be implemented. The communication system 300, which is a part of a communication network, comprises a device 110 which supports the service discovery function (for example, a Network Function Repository Function). For the purpose of illustrations, the device 110 used herein refers to the network repository function (NRF) device 110. The communication system 100 comprises devices 120-1, 120-2, . . . , 120-N which support network functions. For the purpose of illustrations, the device 120 used herein refers to the NF devices 120. The communication system 100 may also comprise a device 130 which can manage virtual network functions. For the purpose of illustrations, the device 130 used herein refers to the VNF manager 130. The communication system 100 also comprises one or more communication devices 140. The NF devices 120 may register with the NRF device 110. It should be understood that the communication system 100 may also comprise other elements which are omitted for the purpose of clarity. It is to be understood that the numbers of devices shown in FIG. 1 are given for the purpose of illustration without suggesting any limitations. The term “function” used herein refer to functionality or a node/device/element that can implement the functionality.

Communications in the communication system 100 may be implemented according to any proper communication protocol(s), including, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, including but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

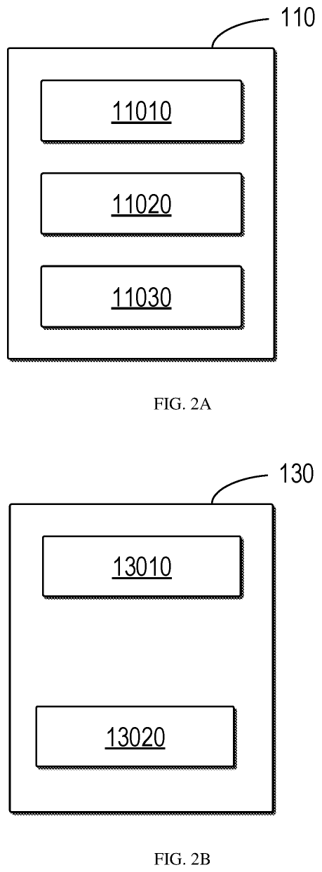

FIG. 2A illustrates a schematic diagram of the NRF 110 in accordance with embodiments of the present disclosure. As shown in FIG. 2A, the NRF device 110 may comprise a module 11010 for providing VNF controlling policy, a module 11020 for VNF controlling, and a module 11030 for VNF operation advisor. As shown in FIG. 2B, the VNF manager 130 may comprise a module 13010 for executing instructions and a module 13020 for transmitting requires. Details of the modules will be given later. It should be noted that the modules shown in FIGS. 2A and 2B are only examples.

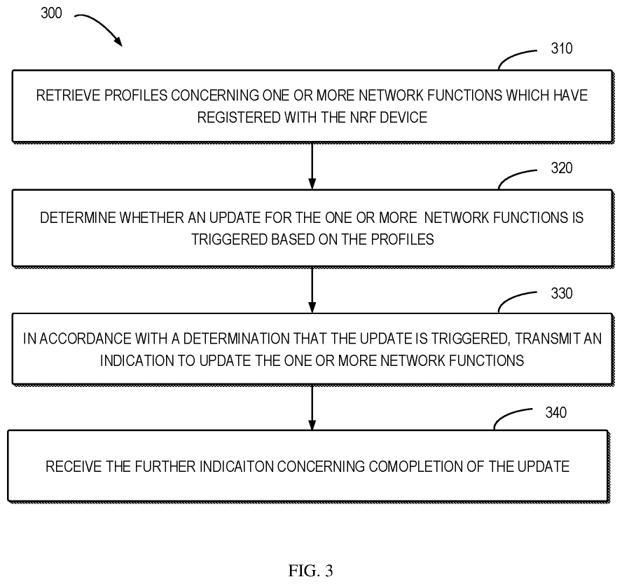

FIG. 3 illustrates a flow chart of a method 300 in accordance with embodiments of the present disclosure. The method 300 may be implemented at any suitable devices. Only for the purpose of illustrations, the method 300 is described to be implemented at the NRF device 110.

At block 310, the NRF device 110 retrieves profiles of one or more network functions 120. The one or more network functions 120 have registered with the NRF device 110. The term “network function” used herein refers to a functional building block within a network infrastructure, which has external interfaces and functional behaviours and supports certain services. In practical terms, a network function is often a network node or physical appliance. The profiles indicate services supported by the one or more network functions 120. The profiles further indicate usage conditions of the one or more network functions 120. For example, the usage conditions may indicate capacities of the one or more network functions 120. Alternatively or in addition, the usage conditions may indicate capabilities of the one or more network functions 120. In other embodiments, the usage conditions may indicate durations of the one or more network functions.

In some embodiments, if the NRF device 110 receives a request for a service from the communication device 140, the NRF device 110 retrieves the profile based on the request. Alternatively or in addition, the NRF device 110 may retrieve the profiles periodically. The period of the retrieving may be determined by the NRF device 110, for example, based on historical data.

At block 320, the NRF device 110 determines whether an update for the one or more network functions is triggered based on the profiles. The update may comprise creation of a new network function. Alternatively or in addition, the update may comprise an increase of capacities of an existing network function. In other embodiments, the update may comprise adding a new capability to an existing network function. In some embodiments, the update may comprise a decrease of capacities of an existing network function.

In some embodiments, the NRF device 110 may receive a request for a service from the communication device 140. The NRF device 110 may determine a target network function to implement the service based on the request. If the NRF device 100 cannot retrieve the profile of the target network function, which means the target network function does not register with the NRF device 110, the update for the network functions 120 is triggered.

Alternatively or in addition, the NRF device 110 may determine the target network function based on the request and the services supported by the network functions 120. If the NRF device 110 is able to retrieve the profile of the target network function, it means the target network function has registered with the NRF device 110. The NRF device 100 may determine whether the target network function is overloaded based on the usage conditions. Alternatively or in addition, the NRF device 110 may determine whether the target network function is overloaded based on the usage conditions during its periodical retrieving. If the NRF device 110 determines that the target network function is overloaded, the update is triggered.

In other embodiments, if the NRF device 110 may determine the capacity of the target network function is wasted based on the usage conditions, the update is triggered. For example, the network function has relatively low working load.

In this way, the network function can be updated dynamically. The resources of the network function can be utilized more efficiently.

In other embodiments, the NRF device 110 may determine the target network function based on the request and the services supported by the network functions 120. If the NRF device 110 is able to retrieve the profile of the target network function, it means the target network function has registered with the NRF device 110. The NRF device 100 may determine whether a target capability/feature of the target network function is missed based on the usage conditions. Alternatively or in addition, the NRF device 110 may determine whether a target capability/feature of the target network function is missed based on the usage conditions during its periodical retrieving. If the NRF device 110 determines that the target capability is missed, the update is triggered.

As shown in FIG. 2A, the module 11010 in the NRF device 110 may comprise VNF controlling policy to update the network functions 120. Table 2 shows examples of the VNF controlling policy. It should be noted that Table 2 is only an example not limitation.

TABLE 2

| VNF Management Criteria | Action |
|---|---|
| No NF is found in NF Discovery | Instantiate related NF instance |
| NF doesn’t match the selection criteria | Scaling out related NF |
| since its work load beyond threshold | |
| NF doesn’t match the selection criteria | Upgrade related NF with missed |
| since its specific capability/feature | capability (Alternatively, |
| missed | Instantiate another related NF |
| | instance) |
| NF is not used by NF consumer beyond | Terminate related NF |
| predefined timeslot | |

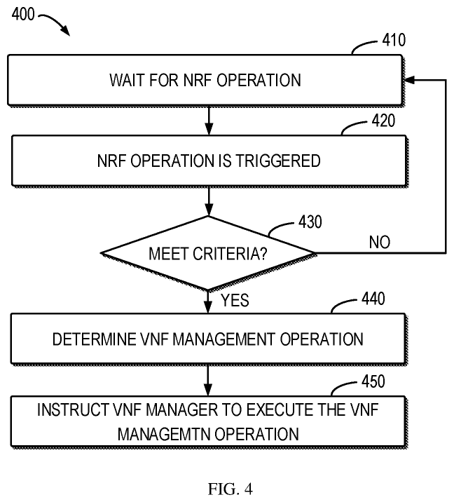

By way of an example, FIG. 4 illustrates a flow chart of a method 400 for determining whether the update is triggered according to some embodiments of the present disclosure. The method 400 may be implemented at the module 11020 shown in FIG. 2A.

At block 410, the module 11020 may wait for an NRF operation. For example, the NRF operation may be a request for a service which can be supported by the NF.

At block 420, the module 11020 may determine whether the NRF operation is triggered. For example, in the Nnrf_NFDiscovery Request handling, if no available NF is found in the NRF device 110 or all NF registered on the NRF device 110 doesn't match the Nnrf_NFDiscovery_Request or internal selection policies of the NRF device 110 for some reason (for example, high working load, the NRF operation is triggered.

At block 420, the module 11020 may determine whether the operation meets the VNF controlling policy in the module 11010. Examples of the VNF controlling policy are shown in Table 2 above.

If the operation meets the VNF controlling policy, at block 440, the module 11020 may determine the VNF management operation based on the VNF controlling policy. If the operation does not meet the VNF controlling policy, the module 11020 will wait for the next VNF operation.

Referring back to FIG. 3, at block 330, if the update is triggered, the NRF device 110 transmits an indication to update the one or more network functions to the VNF manager 130. For example, if the NRF device 100 cannot retrieve the profile of the target network function, the indication may indicate to initiate the target network function.

Alternatively or in addition, if the NRF device 110 determines that the target network function is overloaded, the indication may indicate to increase the capacity of the target network function. In other embodiments, if the NRF device 110 may determine the capacity of the target network function is wasted based on the usage conditions, the indication may indicate to decrease the capacity of the target network function. In other embodiments, if the NRF device 110 determines that the target capability is missed, the indication may indicate to add the target capability.

In some embodiments, if the inactive duration of target network function exceeds a threshold duration, the indication may indicate to release the target network function. For example, if the network function is in a remote area and has not been used for long time, the NRF device 110 may determine that the network function can be terminated.

At block 340, the NRF device 110 receives a further indication from the VNF manager 130. The further indication may concern a completion of the update. For example, the indication may indicate whether the update is completed or not.

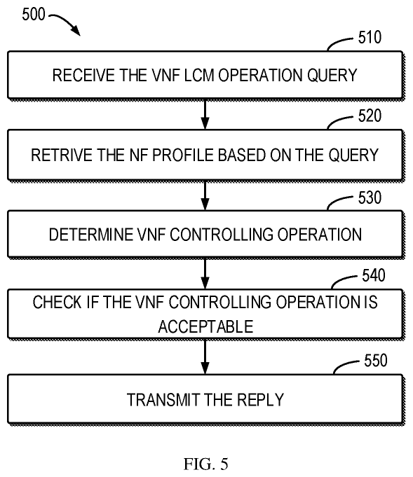

By way of an example, FIG. 5 illustrates a flow chart of a method 500 for supporting life cycle management (LCM) decision according to some embodiments of the present disclosure. The method 400 may be implemented at the module 11030 shown in FIG. 2A.

At block 510, the module 11030 may receive a query from the VNF manager 130. The query may comprise the operation. The operation may comprise one or more of: initiation, capacity increase/decrease, upgrade or release. The query may comprise an identity of the network function.

At block 520, the module 11030 may retrieve the profile of the network function based on the query. For example, the module 11030 may retrieve the profile based on the identity of the network function.

At block 530, the module 11030 may determine a list of acceptable VNF controlling operations based on the network function profiles and the VNF policy.

At block 540, the module 11030 may check if the operation in the query is on the list of acceptable VNF controlling operations. The module 1130, at block 550, may transmit a reply to indicate whether the operation is acceptable or not.

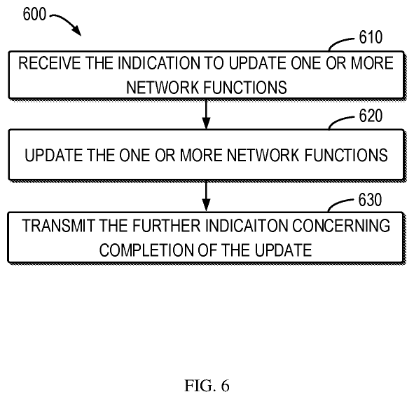

FIG. 6 illustrates a flow chart of a method 600 in accordance with embodiments of the present disclosure. The method 600 may be implemented at any suitable devices. Only for the purpose of illustrations, the method 600 is described to be implemented at the VNF manager 130.

At block 610, the VNF manager 130 receives the indication to update the one or more network functions 120 from the NRF device 110. For example, if the NRF device 100 cannot retrieve the profile of the target network function, the indication may indicate to initiate the target network function. In some embodiments, as shown in FIG. 2B, the module 13010 in the VNF manager 130 may receive the indication.

Alternatively or in addition, if the NRF device 110 determines that the target network function is overloaded, the indication may indicate to increase the capacity of the target network function. In other embodiments, if the NRF device 110 determines that the target capability is missed, the indication may indicate to add the target capability. In some embodiments, if the inactive duration of target network function exceeds a threshold duration, the indication may indicate to release the target network function.

At block 620, the VNF manager 130 updates the one or more network functions based on the indication. In some embodiments, as shown in FIG. 2B, the module 13010 in the VNF manager 130 may execute the update based on the indication.

In some embodiments, if the indication may indicate to initiate the target network function, the VNF manager 130 may initiate the target network function. Alternatively or in addition, if the indication may indicate to increase the capacity of the target network function, the VNF manager 130 may increase the capacity of the target network function. In other embodiments, if the indication may indicate to add the target capability, the VNF manager 130 may add the target capability to the target network function. In some embodiments, if the indication may indicate to release the target network function, the VNF manager 130 may release the target network function. Alternatively or in addition, if the indication may indicate to decrease the capacity of the target network function, the VNF manager 130 may decrease the capacity of the target network function.

At block 630, the VNF manager 130 transmits the further indication to the NRF device 110. The further indication may concern a completion of the update. For example, the indication may indicate whether the update is completed or not.

In some embodiments, the VNF manager 130 may transmit a query to the NRF device 110. For example, as show in FIG. 3B, the module 101013020 may transmit the query to the NRF device 110. The query may comprise the operation. The operation may comprise one or more of: initiation, capacity increase/decrease, upgrade or release. The query may comprise an identity of the network function. The VNF manager 130 may receive a reply from the NRF device 110. The reply may indicate whether the operation indicated in the query is acceptable or not.

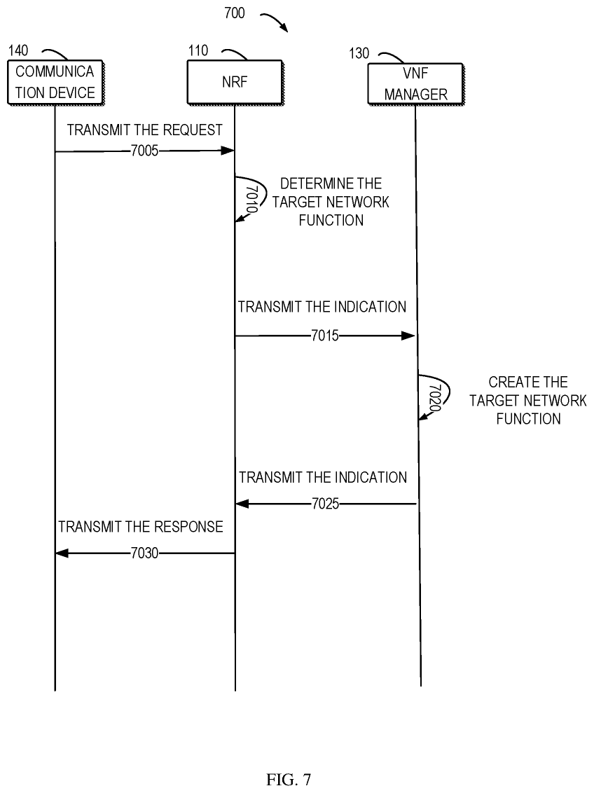

FIG. 7 illustrates a schematic diagram of interactions 700 in accordance with example embodiments of the present disclosure. The interactions 700 may be implemented at any suitable devices. Only for the purpose of illustrations, the interactions 700 are described to be implemented at the NRF device 110, the communication device 140, the VNF manager 130, and the NF devices 120.

The communication device 140 may transmit 7005 the request to the NRF device 110. The NRF device 110 may determine 7010 a target network function to implement the service based on the request. If the NRF device 100 cannot retrieve the profile of the target network function, which means the target network function does not register with the NRF device 110, the update for the network functions 120 is triggered. The NRF device 110 may transmit 7015 the indication to create the target network function. The VNF manager 130 may create 7020 the target network function based on the indication. The VNF manager 130 may transmit 7025 the indication concerning the completion of the creation to the NRF device 110. The NRF device 110 may transmit 7030 the response to the request to the communication device 140.

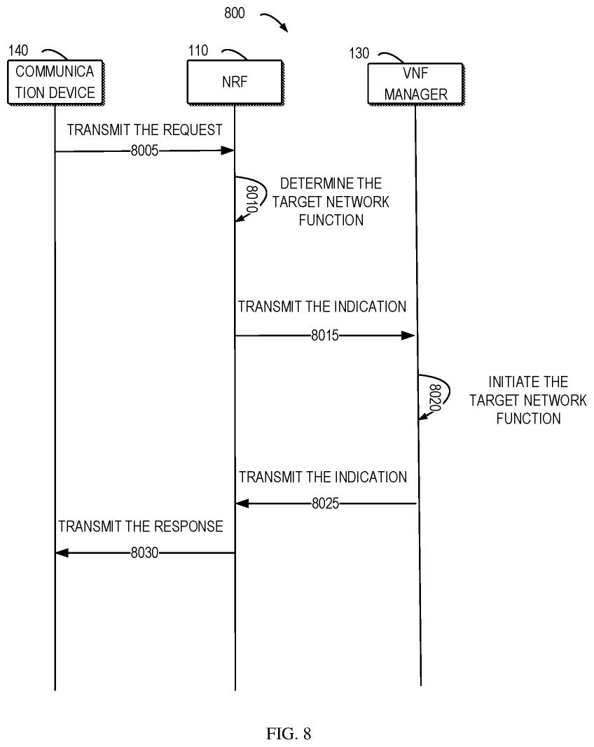

FIG. 8 illustrates a schematic diagram of interactions 800 in accordance with example embodiments of the present disclosure. The interactions 800 may be implemented at any suitable devices. Only for the purpose of illustrations, the interactions 800 are described to be implemented at the NRF device 110, the communication device 140, the VNF manager 130, and the NF devices 120.

The communication device 140 may transmit 8005 the request to the NRF device 110. The NRF device 110 may determine 8010 a target network function to implement the service based on the request. If the target network function is overloaded, the update for the network functions 120 is triggered. The NRF device 110 may transmit 8015 the indication to increase the capacity of the target network function. The VNF manager 130 may create 8020 the target network function based on the indication. The VNF manager 130 may transmit 8025 the indication concerning the completion of the increasing the capacity to the NRF device 110. The NRF device 110 may transmit 8030 the response to the request to the communication device 140.

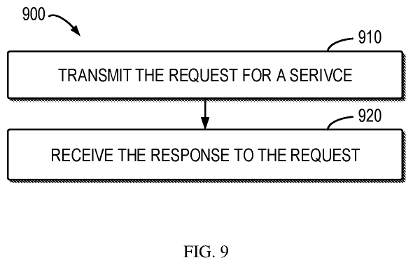

FIG. 9 illustrates a flow chart of a method 900 in accordance with embodiments of the present disclosure. The method 900 may be implemented at any suitable devices. Only for the purpose of illustrations, the method 900 is described to be implemented at the communication device 140. The communication device 140 may be a terminal device.

At block 910, the communication device 140 transmits a request for a service to the NRF device 110. The service can be implemented by a network function. The one or more network functions which have register with the NRF device 110 may be triggered to be updated based on the request. For example, if the one or more network functions cannot implement the service, the update is triggered based on the request. Alternatively or in addition, if the capacities of the one or more network functions are not enough to implement the device, the update is triggered based on the request. In some embodiments, if the one or more network functions lack a target capability to implement the device, the update is triggered based on the request.

At block 920, the communication device 140 receives the response to the request. The request may indicate that the service can be implemented by a target network function registered with the NRF device 110.

In some embodiments, an apparatus for performing the method 300 (for example, the NRF device 110) may comprise respective means for performing the corresponding steps in the method 300. These means may be implemented in any suitable manners. For example, it can be implemented by circuitry or software modules.

In some embodiments, the apparatus comprises means for retrieving, at a first device, profiles concerning one or more network functions which have registered with the first device; means for determining whether an update for the one or more network functions is triggered based on the profiles, the profiles indicating services supported by the one or more network functions and usage conditions of the one or more network functions; means for in accordance with a determination that the update is triggered, transmitting, to a second device, an indication to update the one or more network functions; and means for receiving, from the second device, a further indication concerning completion of the update; and.

In some embodiments, the usage conditions indicate at least one of: capacities of the one or more network functions, capabilities of the one or more network functions, or inactive durations of the one or more network functions.

In some embodiments, the means for determining whether the update is triggered comprises: means for receiving, from a third device, a request for a service; means for determining a target network function to implement the service based on the request; and means for in accordance with a failure in retrieving a profile of the target network function from the profiles, determining that the update is triggered.

In some embodiments, the means for transmitting the indication to update the network functions comprises: means for transmitting the indication to initiate the target network function.

In some embodiments, the means for determining whether the update is triggered comprises: means for receiving, from a third device, a request for a service; means for determining a target network function to implement the service based on the request and the services supported by the one or more network functions; means for determining a profile of the target network function from the profiles; and means for in accordance with a determination that the target network function is overload based on the profile of the target network function, determining that the update is triggered.

In some embodiments, the means for transmitting the indication to update the network functions comprises: means for transmitting the indication to increase a capacity of the target network function.

In some embodiments, the means for wherein determining whether the update is triggered comprises: means for receiving, from a third device, a request for a service; means for determining a target network function to implement the service based on the request and the services supported by the one or more network functions; means for retrieving a profile of the target network function from the profiles; and means for in accordance with a determination that a target capability of the target network function is missed based on the profile of the target network function, determining that the update is triggered.

In some embodiments, the means for transmitting the indication to update the network functions comprises: means for transmitting the indication to upgrade the target network function with the target capability.

In some embodiments, the apparatus comprises means for transmitting a response to the request to the third device.

In some embodiments, the means for determining whether the update is triggered comprises: means for determining, based on the usage conditions, a target network function with an inactive duration exceeding a threshold duration; and means for determining that the update is triggered.

In some embodiments, the means for transmitting the indication to update the network functions comprises: means for transmitting the indication to release the target network function.

In some embodiments, the apparatus comprises means for receiving a query from the second device, the query indicating an identity of a target network function and an operation associated with the target network function; means for identifying a profile of the target network function from the profiles; means for determining whether the operation is acceptable based on the identified profile; and means for transmitting a reply to the query to the second device based on the determination of whether the operation is acceptable.

In some embodiments, the first device comprises a network repository function, and the second device comprises a virtual network function manager.

In some embodiments, an apparatus for performing the method 600 (for example, the VNF manager 130) may comprise respective means for performing the corresponding steps in the method 600. These means may be implemented in any suitable manners. For example, it can be implemented by circuitry or software modules.

In some embodiments, the apparatus comprises means for receiving, from a first device and at a second device, an indication to update one or more network functions which have registered with the first device; means for updating the one or more network functions based on the indication; and means for transmitting, to the first device, a further indication concerning completion of the update.

In some embodiments, the means for updating the one or more network functions comprises: means for in accordance with the request indicating to initiate a target network function which excluding from the one or more network functions, initiating the target network function.

In some embodiments, the means for updating the one or more network functions comprises: means for in accordance with the request indicating to increase a capacity of a target network function, increasing the capacity of the target network function.

In some embodiments, the means for updating the one or more network functions comprises: means for in accordance with the request indicating to upgrade a target network function with a capability, upgrading the target network function with the capability.

In some embodiments, the means for updating the one or more network functions comprises: means for in accordance with the request indicating to release a target network function, releasing the target network function.

In some embodiments, the apparatus further comprises means for transmitting a query to the first device, the query indicating an identity of a target network function and an operation associated with the target network function; and means for receiving a reply to the query from the first device, the reply indicating whether the operation is acceptable to the first device.

In some embodiments, the first device comprises a network repository function, and the second device comprises a virtual network function manager.

In some embodiments, an apparatus for performing the method 900 (for example, the communication device 140) may comprise respective means for performing the corresponding steps in the method 900. These means may be implemented in any suitable manners. For example, it can be implemented by circuitry or software modules.

In some embodiments, the apparatus comprises means for transmitting a request for a service to a first device with which one or more network functions have registered, an update of the one or more network functions being triggered based on the request; and means for receiving, a response to the request from the first device, the response indicating the service to be implemented by a network function registered with the first device.

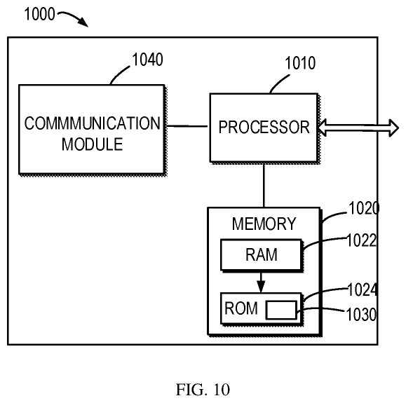

FIG. 10 is a simplified block diagram of a device 1000 that is suitable for implementing embodiments of the present disclosure. The device 1000 may be provided to implement the communication device, for example the NRF device 110 or the VNF manager 130 as shown in FIG. 1. As shown, the device 1000 includes one or more processors 1010, one or more memories 1020 coupled to the processor 1010, and one or more communication module (for example, transmitters and/or receivers (TX/RX)) 940 coupled to the processor 1010.

The communication module 940 is for bidirectional communications. The communication module 940 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1030 so that the device 1000 may perform any process of the disclosure as discussed with reference to FIGS. 3 to 9. The embodiments of the present disclosure may also be implemented by hardware or by a combination of software and hardware.

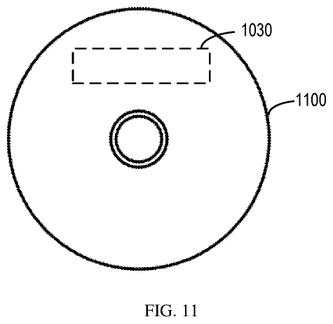

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 10301030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300-600 and interactions as described above with reference to FIGS. 3-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method, comprising:
retrieving, at a first device, profiles concerning one or more network functions which have registered with the first device;
determining whether an update for the one or more network functions is triggered based on the profiles, the profiles indicating services supported by the one or more network functions and usage conditions of the one or more network functions;
in accordance with a determination that the update is triggered, transmitting, to a second device, an indication to update the one or more network functions; and
receiving, from the second device, a further indication concerning completion of the update.

2. The method of claim 1, wherein the usage conditions indicate at least one of:
capacities of the one or more network functions,
capabilities of the one or more network functions, or
inactive durations of the one or more network functions.

3. The method of claim 1, wherein determining whether the update is triggered comprises:
receiving, from a third device, a request for a service;
determining a target network function to implement the service based on the request; and
in accordance with a failure in retrieving a profile of the target network function from the profiles, determining that the update is triggered.

4. The method of claim 3, wherein transmitting the indication to update the network functions comprises:
transmitting the indication to initiate the target network function.

5. The method of claim 1, wherein determining whether the update is triggered comprises:
receiving, from a third device, a request for a service;
determining a target network function to implement the service based on the request and the services supported by the one or more network functions;
determining a profile of the target network function from the profiles; and
in accordance with a determination that the target network function is overload based on the profile of the target network function and/or a determination that a target capability of the target network function is missed based on the profile of the target network function, determining that the update is triggered.

6. (canceled)

7. The method of claim 3, further comprising:
transmitting a response to the request to the third device.

8. The method of claim 1, wherein determining whether the update is triggered comprises:
determining, based on the usage conditions, a target network function with an inactive duration exceeding a threshold duration; and
determining that the update is triggered,
and wherein transmitting the indication to update the network functions comprises:
transmitting the indication to release the target network function.

9. (canceled)

10. The method of claim 1, further comprising:
receiving a query from the second device, the query indicating an identity of a target network function and an operation associated with the target network function;
identifying a profile of the target network function from the profiles;
determining whether the operation is acceptable based on the identified profile; and
transmitting a reply to the query to the second device based on the determination of whether the operation is acceptable.

11. The method of claim 1, wherein the first device comprises a network repository function, and the second device comprises a virtual network function manager.

12. A method, comprising:
receiving, from a first device and at a second device, an indication to update one or more network functions which have registered with the first device;
updating the one or more network functions based on the indication; and
transmitting, to the first device, a further indication concerning completion of the update.

13. The method of claim 12, wherein updating the one or more network functions comprises at least one of:
in accordance with the request indicating to initiate a target network function which excluding from the one or more network functions, initiating the target network function;
in accordance with the request indicating to increase a capacity of a target network function, increasing the capacity of the target network function;
in accordance with the request indicating to upgrade a target network function with a capability, upgrading the target network function with the capability; or
in accordance with the request indicating to release a target network function, releasing the target network function.

14. The method of claim 12, further comprising:
transmitting a query to the first device, the query indicating an identity of a target network function and an operation associated with the target network function; and
receiving a reply to the query from the first device, the reply indicating whether the operation is acceptable to the first device.

15. The method of claim 12, wherein the first device comprises a network repository function, and the second device comprises a virtual network function manager.

16. A method, comprising:
transmitting, at a third device, a request for a service to a first device with which one or more network functions have registered, an update of the one or more network functions being triggered based on the request; and
receiving, a response to the request from the first device, the response indicating the service to be implemented by a network function registered with the first device.

17. The method of claim 16, wherein the first device comprises a network repository function and the third device comprises a terminal device.

18. A first device comprising:
at least one processor; and
a memory coupled to the at least one processor, the memory storing instructions therein, the instructions, when executed by the at least one processor, causing the first device to perform the method of claim 1.

19. A second device comprising:
at least one processor; and
a memory coupled to the at least one processor, the memory storing instructions therein, the instructions, when executed by the at least one processor, causing the second device to perform the method of claim 12.

20. A third device comprising:
at least one processor; and
a memory coupled to the at least one processor, the memory storing instructions therein, the instructions, when executed by the at least one processor, causing the third device to perform the method of claim 16.

21. (canceled)

22. An apparatus comprising circuitry configured to cause the apparatus to perform a process according to claim 1.

23. A computer program embodied on a non-transitory computer-readable storage medium, the computer program comprising program instructions which, when executed by an apparatus, cause the apparatus to perform the method of claim 1.
